(19) United States
(12) Patent Application Publication
(10) Pub. No.: US 2024/0111321 A1
(43) Pub. Date: Apr. 4, 2024

(54) SEMICONDUCTOR DEVICE, REGULATOR CIRCUIT, AND METHOD FOR STARTING REGULATOR CIRCUIT

(71) Applicant: LAPIS Technology Co., Ltd., Yokohama (JP)

(72) Inventor: Yoichi FUEKI, Yokohama (JP)

(73) Assignee: LAPIS Technology Co., Ltd., Yokohama (JP)

(21) Appl. No.: 18/469,822

(22) Filed: Sep. 19, 2023

(30) Foreign Application Priority Data
Sep. 30, 2022 (JP) 2022-159110

(51) Int. Cl. G05F 1/575; G05F 3/26; H02M 1/00; H02M 3/158

(52) U.S. Cl. CPC G05F 1/575; G05F 3/262; H02M 1/0045; H02M 3/158

(57) ABSTRACT

A semiconductor device includes a control circuit that includes a regulator output, an error amplifier circuit controlling a first driving transistor that drives the regulator output, and a switching circuit selectively controlling one or more second driving transistors that drive the regulator circuit through the error amplifier circuit. The semiconductor device further includes a switching determination circuit that includes a current source circuit receiving power from a first power line, a current circuit receiving a current from the current source circuit, a capacitor charged or discharged by the current circuit in response to start-up of the regulator output, and a determinator configured to determine a potential of one electrode of the capacitor and generate a determination signal indicating the determination result. The switching circuit enables or disables the error amplifier circuit to control the second driving transistor in response to the determination signal from the switching determination circuit.

### CROSS REFERENCE TO RELATED APPLICATION

This application is based upon and claims the benefit of priority of the prior Japanese Patent Application No. 2022-159110, filed on Sep. 30, 2022, the entire contents of which are incorporated herein by reference.

### TECHNICAL FIELD

The disclosure relates to a semiconductor device, a regulator circuit, and a method for starting a regulator circuit.

### BACKGROUND ART

Japanese Patent Application Laid-open Publication No. 2005-242665 discloses a constant voltage circuit. This constant voltage circuit includes two output control transistors connected to an output. Those output control transistors are switched through a switching circuit and a switch. The switching circuit operates as prescribed in accordance with a switching control signal, and connects an output terminal of an error amplifier circuit to one of the two output control transistors. Specifically, the switching circuit is configured to use one of the output control transistors at power-on.

### SUMMARY

When starting up a voltage regulator, an inrush current (rush current), specifically a large current that temporarily flows, can flow through the voltage regulator. One method to prevent the voltage regulator from allowing through a large current is limiting the driving capacity of the voltage regulator at start-up. However, this method requires switching from a start-up period to a normal operation. The timing of this switch can be identified by generating a switching signal using a comparator that monitors the output voltage of the voltage regulator, or by generating a switching signal after a certain period of time has passed since start-up.

In the voltage regulator of the background art, the timing at which inrush current flows and the period of time required after start-up may depend on the system in which the voltage regulator is installed.

The disclosure aims at providing a semiconductor device, a regulator circuit, and a method for starting a regulator circuit that can restrict inrush current and generate a switching signal more easily.

A semiconductor device according to one aspect of the disclosure includes: a control circuit that includes a regulator output, an error amplifier circuit configured to control a first driving transistor configured to drive the regulator output, and a switching circuit configured to selectively control one or a plurality of second driving transistors configured to drive the regulator circuit by the error amplifier circuit; and a switching determination circuit that includes a current source circuit configured to receive power from a first power line differing from the regulator output, a current circuit that receives a current from the current source circuit, a capacitor charged or discharged by the current circuit in response to start-up of the regulator output, and a determinator configured to determine a potential of one electrode of the capacitor and generates one or a plurality of determination signals indicating the determination result, wherein the regulator output is configured to receive power from the first power line via at least one of the first driving transistor and the second driving transistor, wherein the switching circuit is configured to enable or disable the error amplifier circuit to control the second driving transistor in response to the determination signal from the switching determination circuit, and wherein the error amplifier circuit operates in response to a difference between a feedback voltage from the regulator output and a reference voltage.

The regulator circuit according to the second aspect of the disclosure includes the semiconductor device according to the first aspect, the first driving transistor, and at least one second driving transistor.

A method for starting a regulator circuit according to a third aspect of the disclosure includes: preparing the regulator circuit according to the second aspect; supplying power to the first driving transistor, the second driving transistor, and the control circuit, the current source circuit, and the determinator of the regulator circuit; supplying power to the current circuit from the regulator output in response to the first driving transistor driving the regulator output; charging or discharging the capacitor in response to the current circuit receiving power; and controlling the second driving transistor in response to the determination result of the determinator after power supply from the regulator output to the current circuit is initiated.

### BRIEF DESCRIPTION OF THE DRAWINGS

FIG. 1 is a diagram schematically showing a semiconductor device and a voltage regulator according to an embodiment of the disclosure.

FIG. 2 is a circuit diagram illustrating a voltage regulator circuit according to an embodiment of the. disclosure

FIG. 3 is a circuit diagram illustrating a switching determination circuit of the semiconductor device according to an embodiment of the disclosure.

FIG. 4 is a circuit diagram illustrating a switching determination circuit of the semiconductor device according to an embodiment of the disclosure.

FIG. 5 is a diagram showing waveforms of major nodes in the circuits illustrated in FIGS. 2, 3 and 4.

FIG. 6 is a flowchart illustrating key steps of a method for starting the semiconductor device and voltage regulator according to an embodiment of the disclosure.

FIG. 7 is a circuit diagram illustrating a switching determination circuit of the semiconductor device according to an embodiment of the disclosure.

FIG. 8 is a circuit diagram illustrating a switching determination circuit of the semiconductor device according to an embodiment of the disclosure.

### DETAILED DESCRIPTION OF EMBODIMENTS

Below, embodiments of the disclosure will be explained in detail with reference to figures. The same or similar reference characters are given to the same or similar components, and redundant descriptions will be abridged.

According to the disclosure, it is possible to provide a semiconductor device, a regulator circuit, a method for starting a regulator circuit that can restrict inrush current and generate a switching signal more easily.

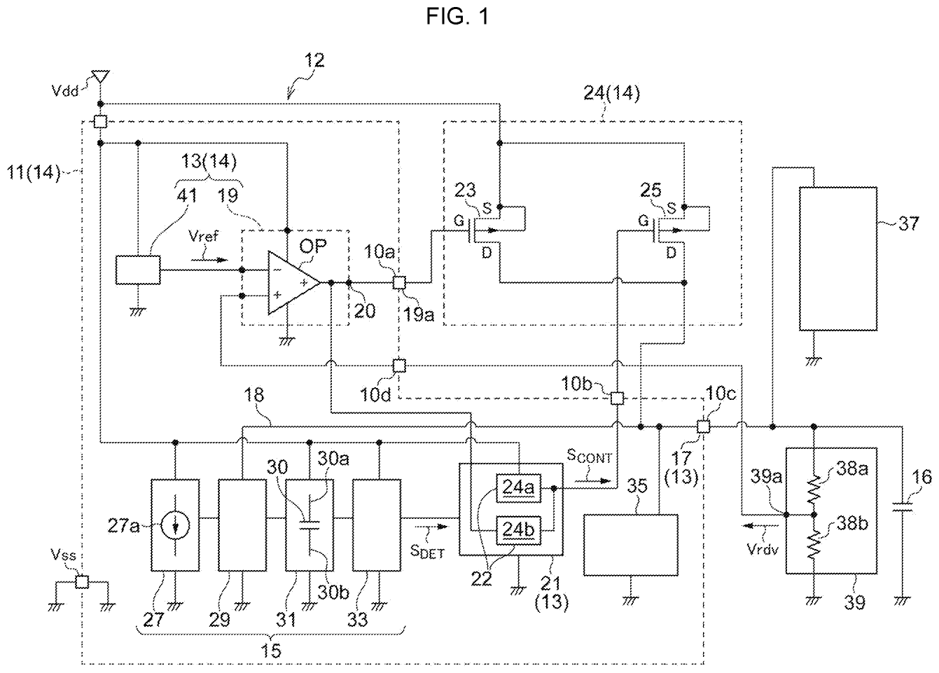

FIG. 1 is a diagram schematically showing a semiconductor device and a voltage regulator according to an embodiment of the disclosure. In FIG. 1, for illustration purpose, a high-power line is referred to as “Vdd” while a low-power line is referred to as “Vss” and denoted with the circuit symbol representing Ground.

A semiconductor device 11 includes a control circuit 13 and a switching determination circuit 15. The control circuit 13 includes a regulator output 17, an error amplifier circuit 19, a control output 20, and a switching circuit 21. The regulator output 17 is connected to an internal power supply line 18 and supplies power to the internal power supply line 18. The control output 20 is connected to the output of the error amplifier circuit 19, which may include, for example, an operational amplifier (op-amp) OP.

The error amplifier circuit 19 is configured to control a first driving transistor 23 that drives the regulator output 17. The switching circuit 21 is configured to operate a second driving transistor 25 that drives the regulator output 17 selectively through the error amplifier circuit 19. The error amplifier circuit 19 operates in response to the difference between the feedback voltage from the regulator output 17 and the reference voltage.

The switching determination circuit 15 includes a current source circuit 27, a current circuit 29, a capacitor circuit 31, and a determinator 33. The current source circuit 27 includes a current source 27a and can be configured to receive power from a first power line (such as Vdd) differing from the regulator output 17. The current circuit 29 is configured to receive a current from the current source circuit 27 and to allow through a current associated with the current flowing through the current source circuit 27. The capacitor circuit 31 includes a capacitor 30. The capacitor 30 is charged or discharged by the current circuit 29 in response to start-up of the regulator output 17. The determinator 33 is configured to determine the potential of one electrode 30a of the capacitor 30 of the capacitor circuit 31, and generate a determination signal S_{DET} that indicates the determination result.

The switching circuit 21 is configured to enable or disable the error amplifier circuit 19 to control the second driving transistor 25 in response to the determination signal S_{DET} from the switching determination circuit 15. The output of the switching circuit 21 is directly connected to the second driving transistor 25.

The voltage regulator 12 can include a regulator circuit 14, a capacitor 16, and an error detection circuit 39. The regulator circuit 14 includes the semiconductor device 11 and a driving circuit 24 (first driving transistor 23 and second driving transistor 25).

The error detection circuit 39 is configured to provide the error amplifier circuit 19 with the feedback voltage from the regulator output 17. Specifically, the error detection circuit 39 is configured not only to divide the voltage of the regulator output 17, but also to provide a divided voltage value Vrdv of the voltage of the regulator output 17 to the positive input (+) of the operation amplifier OP of the error amplifier circuit 19, for example. The negative input (−) of the operation amplifier OP receives the reference voltage Vref. The regulator output 17 is configured to receive power from the first power line Vdd via the first driving transistor 23 and the second driving transistor 25. The error detection circuit 39 is configured as a circuit that divides a voltage, and specifically includes a plurality of resistors 38a and 38b (such as resistive elements, diodes, transistors) connected in series. The shared node of resistors 38a and 38b is connected to the output 39a of the error detection circuit 39 so that a divided voltage value Vrdv is produced at the output 39a.

In the semiconductor device 11, the control circuit 13 may further include a reference voltage generation circuit 41 configured to provide the reference voltage Vref to the error amplifier circuit 19. The error amplifier circuit 19 receives the reference voltage Vref and the divided voltage value Vrdv from the error detection circuit 39, detects the difference ΔV between the divided voltage value Vrdv and the reference voltage Vref, and amplifies the difference ΔV to control the driving transistors (23 and/or 25).

If necessary, the semiconductor device 11 may receive a reference voltage for the error amplifier circuit 19 from outside the semiconductor device 11.

According to the semiconductor device 11, the voltage regulator 12, and the regulator circuit 14, the first driving transistor 23 is controlled using the error amplifier circuit 19 based on the voltage of the regulator output 17 at power-on. In the switching determination circuit 15, the current circuit 29 charges or discharges the capacitor 30 of the capacitor circuit 31 in response to start-up of the regulator output 17. Also, the determinator 33 determines the potential of one electrode 30a of the capacitor 30 being charged or discharged, and generates a determination signal S_{DET} that indicates the determination result. The switching circuit 21 responds to this determination signal S_{DET}, and selectively controls the second driving transistor 25 using the error amplifier circuit 19.

If necessary, the semiconductor device 11 may include the first driving transistor 23 and the second driving transistor 25. Specifically, the first driving transistor 23 and the second driving transistor 25 can be integrated together with the semiconductor device 11 to form a semiconductor integrated circuit (regulator circuit 14), or can be constituted of a semiconductor chip of a separate semiconductor device from the semiconductor device 11.

In FIG. 1, the first driving transistor 23 and the second driving transistor 25 are illustrated as a part of the driving circuit 24. However, the first driving transistor 23 and the second driving transistor 25 may be constituted of a different semiconductor chip from each other. Also, the first driving transistor 23 and the second driving transistor 25 are illustrated with a single circuit symbol, but these transistors (23 and 25) may be arranged to have a plurality of gate electrodes in a semiconductor chip.

In FIG. 1, each of the first driving transistor 23 and the second driving transistor 25 is illustrated with the circuit symbol of field-effect transistor (such as P-channel transistor), but one or both of those transistors may include a bi-polar transistor. In one embodiment, the control terminal of the driving transistor may be the base of a bipolar transistor or the gate of a field-effect transistor. The first current terminal of the driving transistor may be the collector of a bipolar transistor or the source of a field-effect transistor. The second current terminal of the driving transistor may be the emitter of a bipolar transistor or the drain of a field-effect transistor. In the descriptions below and the drawings referenced in those descriptions, the control terminal of a transistor, the first current terminal of a transistor, and the second current terminal of a transistor are respectively denoted with “G”, “S”, and “D”. The substrate terminal of a P-channel transistor and the substrate terminal of an N-channel transistor are respectively connected to the high-power line and the low-power line unless otherwise stated.

The semiconductor device 11 may include an internal circuit 35, for example, and the internal circuit 35 is connected to the regulator output 17 and driven by the voltage regulator 12 and the regulator circuit 14.

The semiconductor device 11 and the voltage regulator 12 may be configured to drive an external circuit 37 integrated in a separate semiconductor chip from the semiconductor device 11.

The current circuit 29 may receive power from the regulator output 17. According to the semiconductor device 11 and the voltage regulator 12, since the current circuit 29 receives power from the regulator output 17, the charge current or discharge current of the current circuit 29 depends on or follows the voltage of the regulator output 17 (or potential change).

The regulator output 17 may be configured to receive power from the first power line Vdd via the first driving transistor 23 and the second driving transistor 25. The determinator 33 may receive power from the first power line Vdd. According to the semiconductor device 11 and the voltage regulator 12, the determinator 33 receives power from the first power line Vdd, and therefore, the operation of the determinator 33 is independent of the voltage of the regulator output 17. If necessary, the determinator 33 may receive power via the regulator output 17.

The regulator output 17 may be configured to receive power from the first power line Vdd via the first driving transistor 23 and one or more second driving transistors 25, and the current source circuit 27 may be configured to receive power from the first power line Vdd. According to the semiconductor device 11, the voltage regulator 12 and the regulator circuit 14, because the current source circuit 27 receives power from the first power line Vdd, the operation of the current source circuit 27 is independent of the voltage of the regulator output 17. If necessary, the current source circuit 27 may receive power from the regulator output 17.

One electrode 30a of the capacitor 30 may be connected to the output of the current circuit 29, and the other electrode 30b of the capacitor 30, which differs from the electrode 30a, may be connected to the first power line Vdd or the second power line (such as Vss) differing from the first power line Vdd. According to the semiconductor device 11, the voltage regulator 12, and the regulator circuit 14, the other electrode 30b of the capacitor 30 may be connected to a high potential power line (e.g., first power line Vdd) or a low potential power line (e.g., ground line Vss) and provide a stable reference potential for charging or discharging.

In the semiconductor device 11, the voltage regulator 12, and the regulator circuit 14, the current source circuit 27 receives power from the first power line Vdd so as to operate independently of the potential of the internal power line 18, while the current circuit 29 is configured to receive power from the internal power line 18. As illustrated in FIG. 1, in this embodiment, the current source circuit 27 and the determinator 33 (capacitor circuit 31 as necessary) are configured to receive power from the first power line Vdd, while the current circuit 29 is connected to the internal power line 18 and receive power from the internal power line 18 so that it operates dependently on or in response to the potential of the internal power line 18.

The regulator circuit 14 included in a single-chip integrated circuit where the driving circuit 24 is integrated together with the semiconductor device 11 may include a plurality of electrodes (pad electrodes, for example). The first driving transistor 23 and the second driving transistor 25 are connected to a pad electrode 10c as the regulator output 17. The output 39a of the error detection circuit 39 is connected to a pad electrode 10d. The regulator output 17 is connected to the capacitor 16 and the error detection circuit 39 via the pad electrode 10c.

When the semiconductor device 11 is configured as a single-chip integrated circuit separately from at least one of the first driving transistor 23 and the second driving transistor 25 of the driving circuit 24, the semiconductor device 11 may include a plurality of electrodes (pad electrodes, for example). The regulator output 17 is connected to the pad electrode 10c. The output 39a of the error detection circuit 39 is connected to the pad electrode 10d. The output of the control circuit 13, or the control output 20 more specifically, is connected to the pad electrode 10a. The output of the switching circuit 21 connected to the second driving transistor 25 is connected to the pad electrode 10b.

According to the semiconductor 11, the voltage regulator 12, and the regulator circuit 14, the switching circuit 21 is configured to enable or disable the error amplifier circuit 19 to control the second driving transistor 25 in response to the determination signal S_{DET} from the switching determination circuit 15. Specifically, the switching circuit 21 connects the output 19a of the error amplifier circuit 19 to the control terminal (gate or base) of the second driving transistor 25 or disconnects the output 19a of the error amplifier circuit 19 from the control terminal (gate or base) of the second driving transistor 25 so that the second drive transistor 25 becomes de-energized, in response to the determination signal S_{DET}.

As described above, the determinator 33 is configured to determine the potential of one electrode 30a of the capacitor 30 of the capacitor circuit 31, and generate a determination signal S_{DET} that indicates the determination result. This determinator 33 may be provided as an example of a switching device.

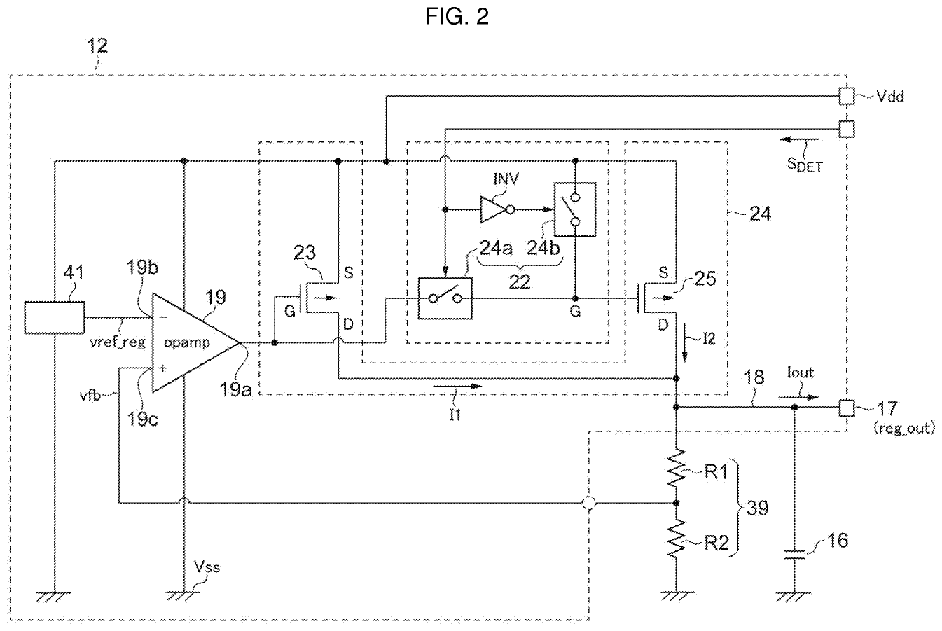

FIG. 2 is a circuit diagram illustrating the voltage regulator according to an embodiment of the disclosure. The voltage regulator 12 of FIG. 2 includes the switching circuit 21 of the semiconductor device 11, the driving circuit 24 (first driving transistor 23 and second driving transistor 25), the error detection circuit 39, and the capacitor 16. The operation amplifier (op-amp) of the error amplifier circuit 19 has a negative input 19b (−) that receives a signal (vref_reg) and a positive input 19c (+) that receives a feedback signal (vfb).

The switching circuit 21 may include a switching device 22 that operates in response to the determination signal S_{DET}. The switching device 22 is configured to enable or disable the output 19a of the error amplifier circuit 19 to control the second driving transistor 25 in response to a signal from the output of the switching determination circuit 15. Specifically, the switching device 22 may be connected between the control terminal (gate or base) of the second driving transistor 25 and the determinator 33 (see FIG. 1). The switching device 22 is configured to enable or disable the output 19a of the error amplifier circuit 19 to control the second driving transistor 25. The switching device 22 may output a signal S_{CONT}.

Specifically, the exemplary switching device 22 may include a first switch 24a and a second switch 24b.

The first switch 24a and the second switch 24b operate as follows when the determination signal S_{DET} corresponding to the switching device 22 indicates that the second driving transistor 25 corresponding to the switching device 22 is inactive. Specifically, the first switch 24a disconnects the second driving transistor 25 corresponding to the switching device 22 from the error amplifier circuit 19, and the second switch 24b makes this second driving transistor 25 de-energized.

The first switch 24a and the second switch 24b operate as follows when the determination signal S_{DET} corresponding to the switching device 22 indicates that the second driving transistor 25 corresponding to the switching device 22 is active. Specifically, the first switch 24a is configured to allow the control terminal of the second driving transistor 25 corresponding to the switching device 22 to be controlled by the signal from the output of the error amplifier circuit 19. The second switch 24b is configured to disconnect the second driving transistor 25 from other power sources or other signal lines so that the second driving transistor 25 can be controlled by the error amplifier circuit 19.

Specifically, the first switch 24a is connected between the output 19a of the error amplifier circuit 19 and the control terminal of the second driving transistor 25. The second switch 24b is connected between the power line that provides a potential to keep the second driving transistor 25 de-energized and the control terminal of the second driving transistor 25. The first switch 24a and the second switch 24b open and close in an exclusive manner. The second switch 24b is configured to make the second driving transistor 24 de-energized when the first switch 24a is open.

By connecting and opening/closing those switches this way, the first switch 24a connects/disconnects the output 19a of the error amplifier circuit 19 to/from the control terminal (gate or base) of the second driving transistor 25. Also, by connecting and opening/closing those switches this way, the second switch 24b is configured to stop an electric current from flowing through the second driving transistor 25 with the control terminal disconnected from the output 19a of the error amplifier circuit 19, for example. This configuration makes the second driving transistor 25 de-energized, for example.

As shown in FIG. 2, the first switch 24a operates in response to the determination signal S_{DET}, and the second switch 24b operates in response to the inverted signal of the determination signal S_{DET}. For the operation of the first switch 24a and the second switch 24b, the switching device 22 may include an inverting gate INV that generates an inverted signal of the determination signal S_{DET} based on the determination signal S_{DET} Each of the first switch 24a and the second switch 24b may include a transmission gate including a transistor, for example, and the transmission gate may include a single-channel transistor or a complementary-channel transistor.

In the driving circuit 24, the first driving transistor 23 provides a current I1 to the regulator output 17 in response to application of the voltage from the first power line Vdd. The second driving transistor 25 provides a current I2 to the regulator output 17 in response to the determination signal S_{DET}. The regulator output 17 (reg_out) provides a current Iout, which is either the current I1 from the first driving transistor 23 or the sum of the current I1 from the first drive transistor 23 and the current I2 from the second driving transistor 25. The exemplary error detection circuit 39 includes resistors R1 and R2 connected in series, and a shared node of the resistors R1 and R2 is connected to the output 39a.

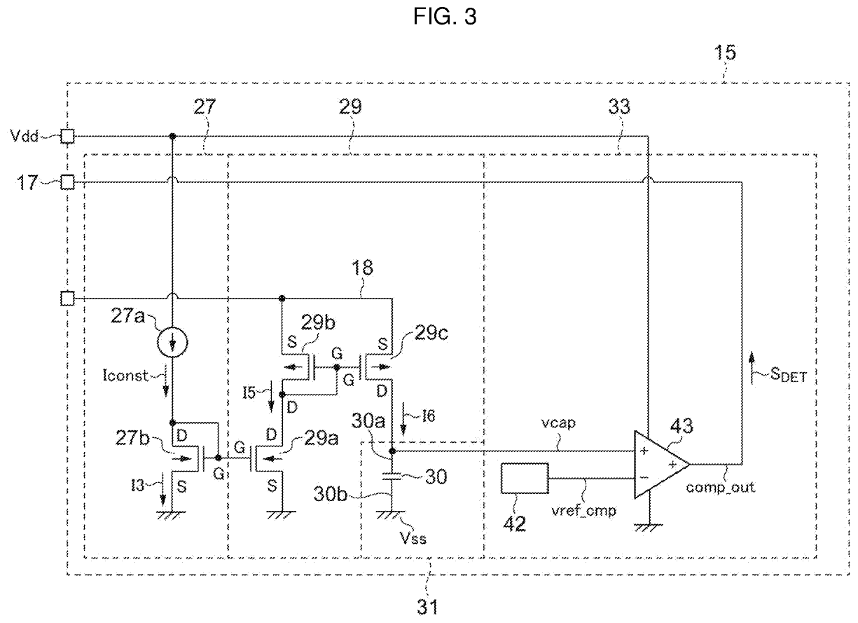

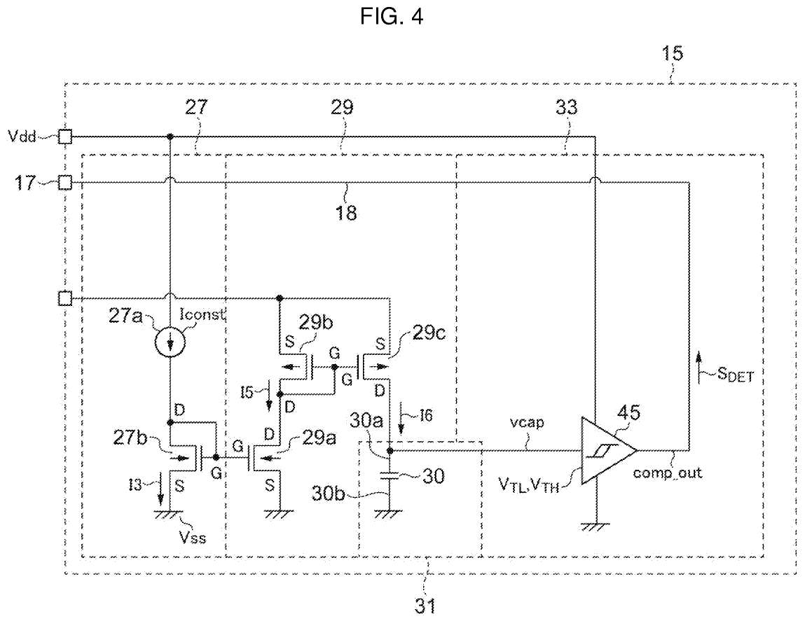

FIG. 3 is a circuit diagram illustrating a switching determination circuit of the semiconductor device according to an embodiment of the disclosure. The switching determination circuit of FIG. 3 includes a comparator. FIG. 4 is a circuit diagram illustrating a switching determination circuit of the semiconductor device according to an embodiment of the disclosure. The switching determination circuit of FIG. 4 includes a Schmitt trigger circuit.

As illustrated in FIGS. 3 and 4, the switching determination circuit 15 includes a current source circuit 27, a current circuit 29, a capacitor circuit 31, and a determinator 33.

The current source circuit 27 includes a constant current source 27a that generates a current Iconst connected to the first power line Vdd, and a transistor 27b (n-type field effect transistor) that receives a current from the constant current source 27a. The drain (D) and gate (G) of transistor 27b are connected so that transistor 27b operates as a diode (hereinafter such a connection is referred to as a “diode connection”) and are connected to the constant current source 27a. The transistor 27b allows through a current I3.

The current circuit 29 includes a transistor 29a (n-type field effect transistor), a transistor 29b (p-type field effect transistor) and a transistor 29c (p-type field effect transistor). The transistor 29b and the transistor 29c receive power from the internal power line 18 connected to the regulator output 17. The gate (G) of the transistor 29a (n-type field effect transistor) is connected to the gate (G) of transistor 27b to receive a mirror current from the transistor 27b, or in other words, the transistor 27b and the transistor 29a form a current mirror circuit. The transistor 29b and the transistor 29c have their gates (G) connected to the drain (D) of the transistor 29b, forming a current mirror circuit. The transistor 29a allows through a mirror current I5 in response to the current I3 of the transistor 27b. The transistor 29b allows through the current I5 from the transistor 29a, and the transistor 29c allows through a mirror current I6 in response to the current I5 of the transistor 29b.

The capacitor circuit 31 is connected to the output of the current circuit 29 to receive or emit the current I6. Specifically, the output of the current circuit 29 is connected to one electrode 30a of the capacitor 30 of the capacitor circuit 31, and the other electrode 30b of the capacitor 30 is connected to either the high potential line (Vdd) or the low potential line (Vss). In this embodiment, the other electrode 30b is connected to the ground line. The capacitor 30 is charged based on the current I6, which increases the potential (vcap) of one electrode 30a (output of the capacitor circuit 31) of the capacitor 30.

The current source circuit 27 and the current circuit 29 may include transistors of the opposite conductivity type to those of the transistors of the current source circuit 27 and the current circuit 29 in the above description. In this case, the other electrode 30b of the capacitor 30 is connected to the power source Vdd. The capacitor 30 is discharged based on the current I6, which decreases the potential of one electrode 30a (output of the capacitor circuit 31) of the capacitor 30.

The output of the capacitor circuit 31 is connected to the input of the determinator 33, and the determinator 33 determines the voltage (vcap) at the output of the capacitor circuit 31.

In Embodiment 1, as illustrated in FIG. 3, the determinator 33 includes at least one comparator circuit 43. The comparator circuit 43 has a positive input (+) that receives the voltage of the output of the capacitor circuit 31 and a negative input (−) that receives the voltage (vref_cmp) from the reference voltage generator 42 that generates the determination voltage. The comparator circuit 43 compares the voltage (vcap) of the output of the capacitor circuit 31 with the voltage (vref_cmp), and generates a determination signal S_{DET} when the voltage (vcap) crosses the voltage (vref_cmp).

In Embodiment 2, as illustrated in FIG. 4, the determinator 33 includes at least one Schmitt trigger circuit 45. The Schmitt trigger circuit 45 has an input that receives the voltage of the output of the capacitor circuit 31, and the inverted threshold value for the input value has a hysteresis characteristic. The Schmitt trigger circuit 45 compares the voltage (vcap) at the output of the capacitor circuit 31 to a threshold voltage (low threshold VTL or high threshold VTH), and generates the determination signal S_{DET} when the voltage (vcap) crosses one of the threshold values.

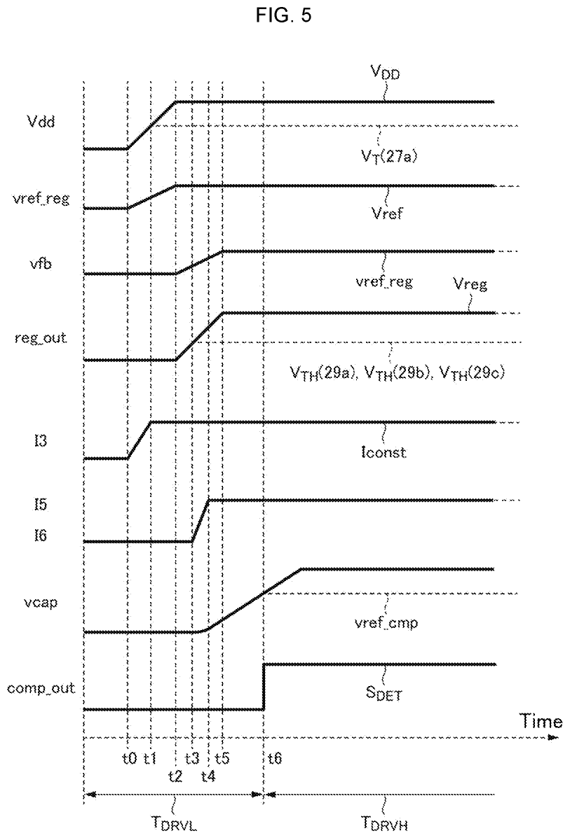

FIG. 5 is a diagram showing waveforms of major nodes in the circuits illustrated in FIGS. 2, 3 and 4. The horizontal axis and vertical axis of FIG. 5 indicate time and voltage waveforms of major nodes, respectively.

At time t0, power is supplied, and the level of the first power line Vdd rises. In response to this rise, the circuits (19, 27, 31, 33, 41) that receive power from the first power line Vdd start operating. In FIG. 5, the waveform (vref_reg) of the reference voltage generation circuit 41 that provides the reference voltage to the error amplifier circuit 19 rises toward the reference voltage Vref in response to the level rise of the first power line Vdd.

At time t1, when the level of the first power line Vdd exceeds the threshold value V_{TH} (27b) of the transistor 27b, the transistor 27b, which was receiving a small current below the threshold value V_{TH} (27b), becomes substantially energized, and the current (I3) of the current source circuit 27 starts to flow. The current source circuit 27 can generate a constant current (Iconst).

At time t2, when the first power line Vdd rises completely, the output (vref_reg) of the reference voltage generation circuit 41 provides the reference voltage Vref. When the error amplifier circuit 19 performs the error amplifying operation, the voltage (reg_out) of the regulator output 17 rises due to power supply from the first driving transistor 23. In response to the voltage rise of the regulator output 17, the feedback voltage vfb from the error detection circuit 39 is given to the error amplifier circuit 19. In response to the rise of the feedback voltage vfb, power supply from the first driving transistor 23 continues. The current circuit 29 receives power from the regulator output 17.

At time t3, when the voltage of the regulator output 17 exceeds the threshold values V_{T} (29b) and V_{T} (29c) of the transistors (29a, 29b, 29c) of the current circuit 29, the current circuit 29 becomes operational, and the capacitor 30 of the capacitor circuit 31 can be charged or discharged. When the capacitor 30 is charged, for example, with a current smaller than a prescribed current value, the voltage (vcap) at the output of the capacitor circuit 31 gradually rises.

At time t4, when the voltage (reg_out) of the regulator output 17 rises to the extent that the transistors (29a, 29c) can operate in the saturation area, the current mirror circuit of the current circuit 29 begins current mirroring. The rise of the voltage (reg_out) of the regulator output 17 allows the capacitor 30 of the capacitor circuit 31 to be charged or discharged with a constant current. The voltage of the output (vcap) of the capacitor circuit 31 changes linearly.

At time t5, the voltage (reg_out) of the regulator output 17 becomes substantially a normal voltage Vreg, and in response to this, the feedback voltage vfb from the error detection circuit 39 becomes constant.

At time t6, when the determinator 33 detects that the voltage of the output (vcap) of the capacitor circuit 31 crosses the determination value, the determination signal S_{DET} is generated. In response to the generation of the determination signal S_{DET}, the driving circuit 24 enables the error amplifier circuit 19 to control the second driving transistor 25, increasing the driving capability of the regulator.

The waiting period Time from time t4 to the generation of the determination signal S_{DET} is approximately calculated by the following equation:

Time=(capacity of the capacitor 30)×(determination voltage of the determinator 33)/(output current 16 of the current circuit 29).

The waiting period Time may be adjusted to pass time t5 at which the voltage of the regulator output 17 reaches a desired voltage. This adjustment can be done by changing the capacity of the capacitor, the determination voltage of the determinator 33, and/or the output current I6 of the current circuit 29.

As understood from the description above, when the power is turned on, the regulator output 17 is started by the first driving transistor 23 so that the voltage regulator 12 and the regulator circuit 14 generate a stable control voltage. Then after the voltage regulator is properly operated, or in other words, the voltage regulator is up and running, the second driving transistor 25 is operated, in addition to the first driving transistor 23, to enhance the current driving capability of the regulator output 17.

According to the semiconductor device 11, the voltage regulator 12, and the regulator circuit 14 of this embodiment, it is possible to prevent the driving capability of the driving circuit 24 from changing while the voltage regulator 12 is still starting up. This way, a large current is not supplied at start-up of the voltage regulator 12, which solves the problems caused by the voltage change of the regulator output 17.

According to the semiconductor device 11, the voltage regulator 12 and the regulator circuit 14 of this embodiment, the current of the current circuit 29 is associated with the voltage of the regulator output 17. Thus, the waiting period Time is associated with the voltage change of the regulator output 17. This means that problems that might occur when the circuit does not have such association, such as insufficient waiting period or excessive waiting period, are less likely to happen.

As understood from the description above, in this embodiment, the voltage regulator 12 may include the regulator circuit 14, the capacitor 16, and the error detection circuit 39. The regulator circuit 14 includes the control circuit 13, the switching determination circuit 15, the regulator output 17, and the driving circuit 24. The capacitor 16 and the error detection circuit 39 are connected to the regulator output 17. The control circuit 13 includes the regulator output 17, the control output 20, the error amplifier circuit 19, the switching circuit 21, and the reference voltage generation circuit 41. The control output 20 is connected to the output of the error amplifier circuit 19.

The driving circuit 24 may include the first driving transistor 23, the error amplifier circuit 19 configured to control the first driving transistor 23, and at least one second driving transistor 25. The switching circuit 21 enables the error amplifier circuit 19 to selectively control the second driving transistor 25.

The regulator output 17 is configured to receive power from the first power line Vdd via the first driving transistor 23 and the second driving transistor 25. Thus, in the normal state, the first driving transistor 23 and the second driving transistor 25 can provide the regulator output 17 with the power from the first power line Vdd.

The switching determination circuit 15 includes the current source circuit 27, the current circuit 29 connected to the current source circuit 27, the capacitor circuit 31 charged or discharged by the current circuit 29, and at least one determinator 33 configured to determine the potential of the output of the capacitor circuit 31. The capacitor circuit 31 includes at least one capacitor 30 that is charged or discharged by the corresponding current circuit 29. Each determinator 33 is configured to determine the potential of one electrode 30a of the corresponding capacitor 30, and generate a determination signal S_{DET} indicating the determination result.

The driving circuit 24 selectively drives the second driving transistor 25 in the driving circuit 24 in response to the determination signal S_{DET} of the determinator 33.

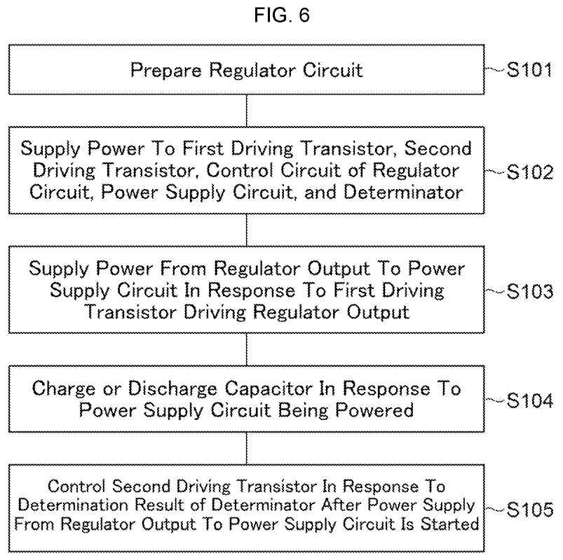

A method for starting the semiconductor device 11 and voltage regulator 12 described above is provided. FIG. 6 is a flowchart showing key steps of this method.

In this method, the semiconductor device 11, the voltage regulator 12, or the regulator circuit 14 is prepared in Step S101. As understood from the embodiment described with FIGS. 1 to 5, the voltage regulator 12 includes the regulator circuit 14, the capacitor 16, and the error detection circuit 39. The regulator circuit 14 may include the semiconductor device 11, the driving circuit 24 (first driving transistor 23 and second driving transistor 25), the error detection circuit 39, and the reference voltage generation circuit 41. The error detection circuit 39 is configured not only to divide the voltage of the regulator output 17, but also to provide the divided voltage value Vrdv to the error amplifier circuit 19 of the semiconductor device 11. The reference voltage generation circuit 41 is configured to provide the reference voltage to the error amplifier circuit 19 of the semiconductor device 11.

In Step S102, power is supplied to the first driving transistor 23, the second driving transistor 25, and the control circuit 13, the current source circuit 27, and the determinator 33 of the voltage regulator 12 from the voltage Vdd.

In Step S103, power is supplied from the regulator output 17 to the current circuit 29 in response to the first driving transistor 23 driving the regulator output 17.

In Step S104, the capacitor 30 is charged or discharged in response to the current circuit 29 receiving power from the regulator output 17.

In Step S105, the second driving transistor 25 is controlled in response to the determination result of the determinator 33 after power supply from the regulator output 17 to the current circuit 29 is initiated.

According to this method, at start-up of the voltage regulator 12, the first driving transistor 23 is controlled using the value at the output of the error amplifier circuit 19, which is based on the voltage of the regulator output 17. In the switching determination circuit 15, the current circuit 29 charges or discharges the capacitor 30 of the capacitor circuit 31 in response to start-up of the regulator output 17. Also, the determinator 33 determines the potential of one electrode 30a of the capacitor 30 of the capacitor circuit 31 being charged or discharged, and generates a determination signal S_{DET} that indicates the determination result. The second driving transistor 25 can be selectively controlled by the error amplifier circuit 19 using the switching circuit 21 in response to this determination signal S_{DET}.

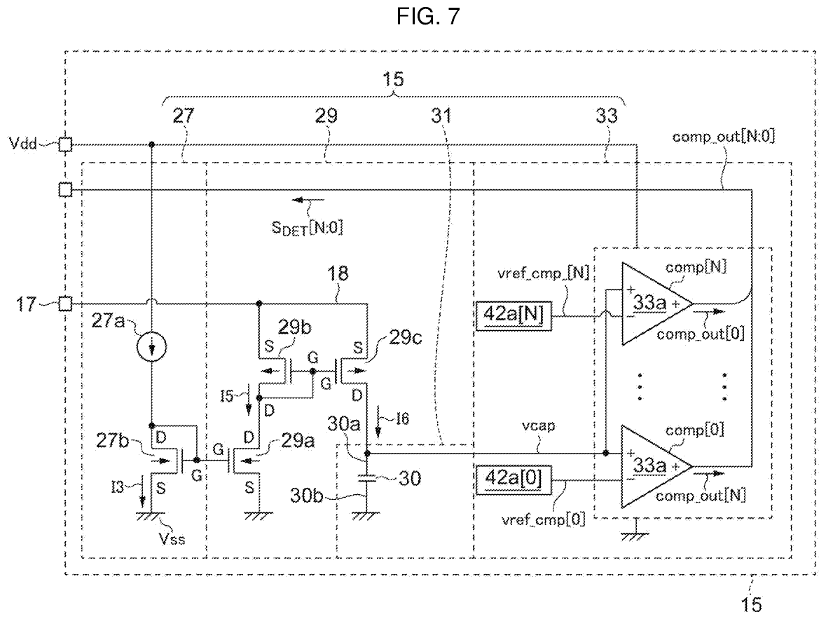

FIG. 7 is a circuit diagram illustrating a switching determination circuit of the semiconductor device of an embodiment of the disclosure. The switching determination circuit 15 of FIG. 7 may include an A/D converter including a plurality of comparators that operate by receiving comparison voltages differing from each other.

In Embodiment 3, the determinator 33 includes a plurality of determination circuits 33a, specifically N+1 comparators comp [0] to comp[N]. The comparators comp [0] to comp[N] receive the output of the capacitor circuit 31 at the respective positive inputs (+) thereof, and the respective negative inputs (−) receive comparison voltages (vref_cmp_[0] to ref_cmp_[N]), respectively. These reference voltages are provided by reference voltage generators 42a [0] to 42a[N] that generate respective determination voltages.

The voltage (vcap) of the output of the capacitor circuit 31 changes through charging or discharging by the current circuit 29. This voltage change is sequentially detected using comparators comp [0] to comp[N] with determination voltages differing from each other. The comparison voltages (vref_cmp_[0] to vref_cmp_[N]) can be arranged in descending order, for example.

As can be seen from the circuit diagrams of FIGS. 1 and 7, the driving circuit 24 includes N+1 second driving transistors 25 corresponding to the N+1 comparators comp [0] to comp [N]. The N+1 second driving transistors 25 respectively operate in response to N+1 determination signals S_{DET} [N:0] (comp_out [0] to comp_out [N]) from the N+1 comparators comp [0] to comp [N]. Specifically, the N+1 second driving transistors 25 are switched by N+1 switching devices 22 that operate in response to the N+1 determination signals S_{DET} [N:0] (comp_out [0] to comp_out [N]). Each of the switching devices 22 may include a first switch 24a and a second switch 24b. The first switch 24a and the second switch 24b of each of the switching devices 22 responds to one of the determination signals S_{DET} [N:0] sent to the switching devices 22.

As understood from FIG. 3 and FIG. 7, according to the semiconductor device 11, the voltage regulator 12, and the regulator circuit 14, one or more comparator circuits 43 can be used for the determinator 33. The comparison threshold values of the comparator circuits 43 may differ from each other. The switching circuit 21 may include switching devices 22 corresponding to the respective comparator circuits 43.

Also, as understood from FIG. 3 and FIG. 7, according to the semiconductor device 11, the voltage regulator 12, and the regulator circuit 14, part or all of the comparator circuits 43 may be replaced with one or more Schmitt trigger circuits 45. One or more Schmitt trigger circuits 45 may also be used for the determinator 33. The switching circuit 21 may include switching devices 22 corresponding to the respective Schmitt trigger circuits 45. At least one of the upper threshold values and the lower threshold values of the Schmitt trigger circuits 45 may differ from each other.

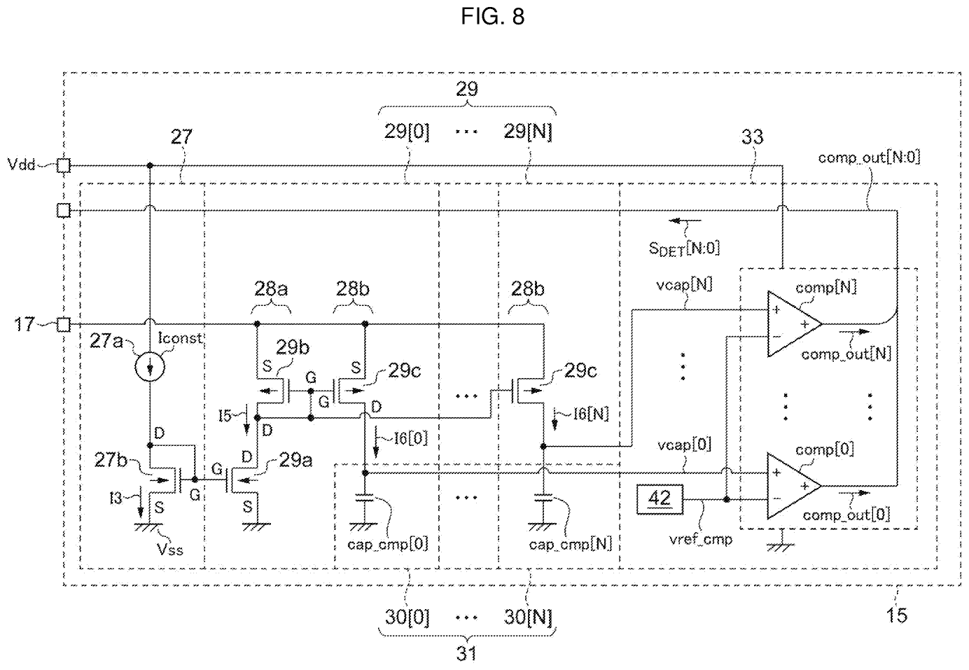

FIG. 8 is a circuit diagram illustrating a switching determination circuit of the semiconductor device of an embodiment of the disclosure. The switching determination circuit 15 of FIG. 8 includes comparators, but part of all of these comparators may be replaced with one or more Schmitt trigger circuits.

In Embodiment 4, the switching determination circuit 15 includes a plurality of current circuits 29. At least one of the current circuits 29 includes a current supply circuit 28a including a transistor 29a and a transistor 29b, and a current branch circuit 28b receiving a mirror current from the current supply circuit 28a. The remaining current circuits 29 may each include a current branch circuit 28b connected to the current supply circuit 28a and receiving a mirror current. Each of the current branch circuits 28b includes a transistor 29c configured to form a current mirror circuit together with the transistor 29b of the current supply circuit 28a.

Specifically, in the switching determination circuit 15 illustrated in FIG. 8, the current circuit 29 may include, for example, a single current supply circuit 28a and N+1 current branch circuits 28b. The N+1 current branch circuits 28b are denoted with the reference characters “29[0]” to “29[N]”. The capacitor circuit 31 includes N+1 capacitors 30[0] to 30[N] corresponding to the N+1 current branch circuits 28b. The N+1 capacitors 30[1] to 30[N] are connected to outputs of the current branch circuits (29[0] to 29[N]), respectively. The N+1 capacitors 30[0] to 30[N] (cap_cmp [0] to cap_cmp [N]) are connected to positive inputs (+) of the comparators comp [0] to comp[N]. The output voltages (vcap [0] to vcap [N]) of the N+1 capacitors 30[1] to 30[N] change through charging or discharging by the current branch circuits 29[0] to 29[N]. The voltage changes of these capacitors 30[0] to 30[N] are detected using the respective comparators comp [0] to comp [N]. The comparators comp [0] to comp [N] receive, at the respective negative inputs (−), a common determination voltage (such as a voltage vref_cmp) from the reference voltage generator 42.

The driving circuit 24 includes N+1 second driving transistors 25 corresponding to the N+1 comparators comp [0] to comp [N]. The N+1 second driving transistors 25 respectively operate in response to N+1 determination signals S_{DET} [N:0] (comp_out [0] to comp_out [N]) from the N+1 comparators comp [0] to comp [N]. Specifically, the N+1 second driving transistors 25 are switched by N+1 switching devices 22 that operate in response to the N+1 determination signals S_{DET} [N:0] (comp_out [0] to comp_out [N]). Each of the switching devices 22 may include a first switch 24a and a second switch 24b. The first switch 24a and the second switch 24b of each of the switching devices 22 responds to corresponding one signal of the determination signals S_{DET} [N:0] sent to the switching devices 22.

In this embodiment, at least one of these modes may be applied:
Mode 1: The current branch circuits (29[0] to 29[N]) generate mirror currents I6[0] to I6[N] differing from each other.
Mode 2: The N+1 capacitors 30[0] to 30[N] respectively have capacitance values cap_cmp [0] to cap_cmp [N] differing from each other.

According to the semiconductor device 11, the voltage regulator 12, and the regulator circuit 14, one or more comparator circuits 43 can be used for the determinator 33. The switching circuit 21 may include switching devices 22 corresponding to the respective comparator circuits 43. In addition, according to the semiconductor device 11, the voltage regulator 12, and the regulator circuit 14, one or more Schmitt trigger circuits 45 can be used for the determinator 33. The switching circuit 21 may include switching devices 22 corresponding to the respective Schmitt trigger circuits 45.

As described with reference to FIGS. 7 and 8 above, the switching determination circuit 15 may include a plurality of determination circuits (43, 45) such as the comparator circuit 43 or the Schmidt trigger circuit 45 to generate a plurality of determination signals S_{DET}[N:0]. Specifically, according to the semiconductor device 11, the voltage regulator 12, and the regulator circuit 14, the determinator 33 may be any of the following: a plurality of comparator circuits 43, a plurality of Schmitt trigger circuits 45, at least one comparator circuit 43, or at least one Schmitt trigger circuit 45.

As described with reference to FIGS. 7 and 8 above, the switching determination circuit 15 may include a plurality of charge/discharge circuits (29, 30, 31), and the determinator 33 generates determination signals S_{DET} [N:0] corresponding to respective charge/discharge circuits (29, 30, 31).

The disclosure is not limited to the above-mentioned embodiments, and various modifications may be made without departing from the scope of the disclosure. All of those modifications are encompassed within the technical concept of the disclosure.

What is claimed is:

1. A semiconductor device, comprising:
a control circuit that includes a regulator output, an error amplifier circuit configured to control a first driving transistor configured to drive the regulator output, and a switching circuit configured to selectively control at least one second driving transistor by the error amplifier circuit, the at least one second driving transistor being configured to drive the regulator circuit; and
a switching determination circuit that includes a current source circuit configured to receive power from a first power line differing from the regulator output, a current circuit that receives a current from the current source circuit, a capacitor charged or discharged by the current circuit in response to start-up of the regulator output, and a determinator configured to determine a potential of one electrode of the capacitor and generate at least one determination signal indicating a determination result,
wherein the regulator output is configured to receive power from the first power line via at least one of the first driving transistor or the at least one second driving transistor,
wherein the switching circuit is configured to enable or disable the error amplifier circuit to control the at least one second driving transistor in response to the at least one determination signal from the switching determination circuit, and
wherein the error amplifier circuit operates in response to a difference between a feedback voltage from the regulator output and a reference voltage.

2. The semiconductor device according to claim 1, wherein the current circuit receives power from the regulator output.

3. The semiconductor device according to claim 1, wherein the determinator receives power from the first power line.

4. The semiconductor device according to claim 1, wherein the current source circuit receive power from the first power line.

5. The semiconductor device according to claim 1, wherein the determinator includes a comparator circuit or a Schmitt trigger circuit.

6. The semiconductor device according to claim 1, wherein the switching determination circuit includes at least one second current circuit that receives a current from the current source circuit, and at least one second capacitor charged or discharged by the at least one second current circuit in response to start-up of the regulator output,
wherein the determinator is configured to determine a potential of one electrode of the at least one second capacitor, and generate a second determination signal that indicates the determination result, and
wherein the switching circuit is configured to enable or disable the error amplifier circuit to control one of a plurality of the second driving transistors in response to the second determination signal.

7. The semiconductor device according to claim 1, wherein the determinator includes a plurality of comparator circuits,
wherein the switching circuit includes a plurality of switching devices corresponding to the comparator circuits, respectively, and
wherein each switching device is configured to enable or disable an output of the error amplifier circuit to control each of a plurality of the second driving transistors in response to a signal from an output of each of the comparator circuits.

8. The semiconductor device according to claim 6, wherein the determinator includes a plurality of Schmitt trigger circuits,
wherein the switching circuit includes a plurality of switching devices corresponding to the Schmitt trigger circuits, respectively, and
wherein each switching device is configured to enable or disable an output of the error amplifier circuit to control each of the second driving transistors in response to a signal from an output of each of the Schmitt trigger circuits.

9. The semiconductor device according to claim 6, wherein the determinator includes a plurality of comparator circuits respectively connected to one electrode of the capacitor and one electrode of the second capacitor, and
wherein the comparator circuits receive a reference voltage from a reference voltage generator.

10. The semiconductor device according to claim 1, wherein the determinator includes an A/D converter including a plurality of comparators that operate in response to comparison voltages differing from each other,
wherein the switching circuit includes a plurality of switching devices corresponding to respective comparators, and
wherein each of the switching devices is configured to enable or disable an output of the error amplifier circuit to control the at least one second driving transistor in response to a signal from each of outputs of the A/D converter.

11. The semiconductor device according to claim 7, wherein each of the switching devices includes a first switch and a second switch,
wherein the first switch is configured to close such that the error amplifier circuit controls each of the second driving transistors corresponding to the switching device when a determination signal corresponding to the switching device indicates that the second driving transistor is active,
wherein the first switch is configured to open such that the error amplifier circuit is separated from the second driving transistor corresponding to the switching device when the determination signal corresponding to the switching device indicates that the second driving transistor corresponding to the switching device is inactive, and
wherein the second switch is configured to make the corresponding second driving transistor de-energized when the first switch is open.

12. A regulator circuit, comprising:
the first driving transistor;
the at least one second driving transistor; and
the semiconductor device according to claim 1.

13. A method for starting a regulator circuit, comprising:
preparing the regulator circuit according to claim 12;
supplying power to the first driving transistor, the second driving transistor, and the control circuit, the current source circuit, and the determinator of the regulator circuit;
supplying power to the current circuit from the regulator output in response to the first driving transistor driving the regulator output;
charging or discharging the capacitor in response to the current circuit receiving power; and
controlling the at least one second driving transistor in response to the determination result of the determinator after power supply from the regulator output to the current circuit is initiated.
